(19) United States
(12) Patent Application Publication
(10) Pub. No.: US 2007/0248323 A1
(43) Pub. Date: Oct. 25, 2007

(54) Disk recording device

(75) Inventor: Satomi Watanabe, Osaka (JP)

Correspondence Address: PILLSBURY WINTHROP SHAW PITTMAN, LLP;Eric S. Cherry - Docketing Supervisor, P.O. BOX 10500, MCLEAN, VA, 22102, US

(73) Assignee: FUNAI ELECTRIC CO., LTD., Osaka (JP)

(21) Appl. No.: 11/730,912

(22) Filed: Apr. 4, 2007

(30) Foreign Application Priority Data
Apr. 5, 2006 (JP) 2006-104115

(51) Int. Cl. H04N 7/00

(52) U.S. Cl. 386/95

(57) ABSTRACT

The disk recording device according to the present invention comprises a control unit, a recording/reading unit, an actuation unit, and so on. If the disk menu upon the optical disk (i.e. the menu for actuation) is one for some other manufacturer, then the control unit receives confirmation in advance upon an initial setting menu as to whether to change the disk menu upon the optical disk for the one in the DVD recorder. If confirmation is ON, then the control unit commands the recording/reading unit to rewrite the disk menu upon the optical disk automatically without performing rewriting confirmation. And the recording/reading unit starts video recording when the disk menu is rewritten.

### CROSS REFERENCE

This Nonprovisional application claims priority under 35 U.S.C. §119(a) on Patent Application No. 2006-104115 filed in Japan on Apr. 5, 2006, the entire contents of which are hereby incorporated by reference.

### BACKGROUND OF THE INVENTION

In the prior art, a DVD recorder has been implemented (in Japanese Laid-Open Patent Publication 2005-332553 etc.), in which actuation has been made simple and easy by outputting, to a television reception device or the like, a screen with a disk menu which is operated for performing replay or recording or the like of a still image or of a moving image. And DVD recorders made by various companies internally store disk menus which are unique to those companies. Furthermore, when recording an image upon an optical disk, such a DVD recorder copies this disk menu to the optical disk at a timing which is determined in advance (for example upon finalization, or when recording of the title is completed).

General information for the disk menu which is recorded upon an optical disk is recorded in a file VRMI_GI (Video Recording Manager Information—General Information) upon the optical disk. A manufacturer ID (identification) and a menu layout ID and the like are recorded in this file VRMI_GI. The manufacturer ID is an ID for identification which is allocated to each manufacturing company. And the menu layout ID is an ID which distinguishes each of a plurality of menus prepared by that company, and which are provided upon the various products of that company.

Since DVD recorders are manufactured by a variety of companies, sometimes it happens that, upon an optical disk which is loaded into a DVD recorder, a disk menu for a different company may be recorded. In this case, the manufacturer ID and the menu layout ID are different from those of the current DVD recorder. In this type of case in which, upon a disk loaded into a DVD recorder, a disk menu of a different company is recorded, depending upon the specification of the DVD recorder, it is possible that it will not be possible to perform new recording upon this disk, even if it is a disk which actually is capable of being rewritten, such as a DVD-RW or the like, or a disk upon it is possible to add to the data, such as a DVD-R or the like. In this situation, in order to perform recording upon this optical disk, it is necessary to rewrite the disk menu and the manufacturer ID and menu layout ID to those of the DVD recorder which is now in use.

In order to satisfy this requirement, in the prior art, a selection screen is displayed upon which the user is invited to select whether or not he consents to the disk menu which is recorded upon the optical disk being rewritten to the disk menu which is stored upon the DVD recorder into which this optical disk is currently loaded, and confirmation for of this rewriting is performed upon this selection screen. When confirmation of this rewriting is thus performed, the disk menu and the IDs recorded upon the optical disk are rewritten.

Furthermore, the generation of data and so on for the menu screen is disclosed in, for example, Japanese Laid-Open Patent Publication 2003-92720 etc. In this Japanese Laid-Open Patent Publication 2003-92720 there is disclosed a DVD video device which, while employing a unified and standardized format as the format for the data of the menu screen, generates symbols which denote the menu items, not as sub-picture data, but as still image data, in order to generate the data of the menu screen at a cheap price.

However, with the prior art technique described above, there has been the problem that the selection screen which asks the user to select whether or not rewriting should be performed of the menu stored in the disk recording device is displayed each time, so that this confirmation actuation is troublesome from the point of view of the user, and it has not been possible to perform video recording directly without this intermediate confirmation step.

Accordingly the present invention has been conceived in the light of this type of problem, and its object is to provide a disk recording device which, when performing additional or rewrite picture recording upon an optical disk, can perform recording without any troublesome confirmation operation, even when it is impossible to perform recording without rewriting the disk menu recorded upon the optical disk to the menu of the disk recording device which is currently being used.

### SUMMARY OF THE INVENTION

The disk recording device according to the present invention comprises a recording means, an ID information decision means, a menu rewrite reception means, and menu rewriting means.

The recording means records data upon an optical disk which is loaded to a main body of the device.

The ID information decision means decides whether or not first ID information, which is ID information recorded upon the loaded optical disk for a first disk menu also recorded thereupon, and second ID information, which is ID information stored in the disk recording device for a second disk menu also stored therein, agree with one another.

The menu rewrite reception means receives in advance a rewrite command to rewrite the disk menu.

And, if this rewrite command has been received in advance by the menu rewrite reception means, and if the ID information decision means decides that the first ID information and the second ID information do not agree with one another, then the menu rewriting means rewrites, using the recording means, the first disk menu and the first ID information recorded upon the optical disk to the second disk menu and the second ID information stored in the disk recording device.

### BRIEF DESCRIPTION OF THE DRAWINGS

FIG. 1 is a block diagram showing the structure of the main portion of a DVD recorder which is an embodiment of the present invention;

FIG. 2 is a flow diagram showing the shifting of sub-screens of a setup screen; and

FIG. 3 is a flow chart showing the processing upon receipt by a control unit from an actuation unit of a command for recording, or of a command for making an appointment for recording.

### DETAILED DESCRIPTION OF THE INVENTION

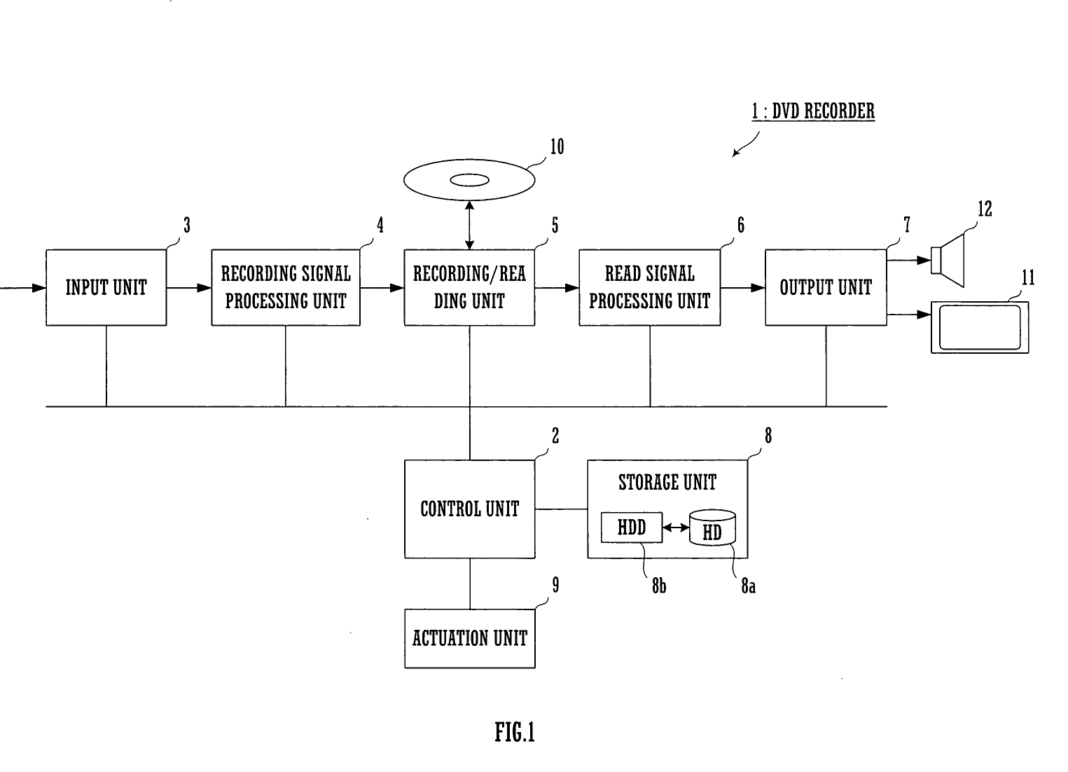

FIG. 1 is a block diagram showing the structure of the main portion of a DVD recorder which is an embodiment of the present invention. The DVD recorder of this embodiment comprises a control unit 2, an input unit 3, a recording signal processing unit 4, a recording/reading unit 5, a read signal processing unit 6, an output unit 7, a storage unit 8, and an actuation unit 9.

The control unit 2 controls the operation of the main body of the device. A title (program) to be recorded upon a DVD which is loaded into the main body of the device is inputted to the input unit 3. The recording signal processing unit 4 generates recording data to be recorded upon the DVD for the title inputted to the input unit 3. The recording/reading unit 5 performs processing to record the recording data generated by the recording signal processing unit 4 upon the DVD, and to read out recorded data for a title recorded upon the DVD. The read signal processing unit 6 processes recorded data for a title which the recording/reading unit 5 has read out from the DVD, and the output unit 7 outputs a replay signal based upon this recorded data which has been processed by the read signal processing unit 6. The storage unit 8 stores a replay history for each DVD. And the actuation unit 9 receives input actuation for the device main body.

The DVD recorder 1 of this embodiment performs recording (video recording) of a title upon a DVD, and replay of a title which is recorded upon a DVD. To give examples of DVDs 10 which can be loaded into the DVD recorder 1 of this embodiment, these may be DVD-RWs or the like which can be rewritten, or write-once optical disks such as DVD-Rs or the like to which additional writing can be performed. By “rewriting” is meant that data which has already been recorded can be deleted, updated, and rewritten.

Since a DVD-RW is rewritable, and this includes the read-in region as well, accordingly it is often the case that the disk management information is recorded according to the standard procedure in the read in region, since no problem arises if the RMA region becomes full. In this case, since even a DVD which has been recorded upon a recorder of another manufacturer can be read by this DVD recorder 1 of this embodiment, accordingly it can be used by this DVD recorder 1 without any problem.

By contrast, with the write-once optical disk such as a DVD-R or the like, the RMA (Recording Management Area, record management region) is of limited capacity, and the problem of this region becoming full or the like can easily occur. In order to avoid this, sometimes recording is performed in a region of the optical disk outside the standard one, and, in the case of a disk such as one which has been recorded with a DVD recorder of a different make, it may be the case that this disk cannot be read with the current DVD recorder 1. Accordingly this disk cannot be used with the DVD recorder 1 of this embodiment. Furthermore, it is not possible to perform additional recording upon a DVD-R or the like which has been finalized, so that this type of disk also cannot be used with this DVD recorder 1. On the other hand, with a rewritable type optical disk such as a DVD-RW or the like, even if it has been finalized, it can still be used with this DVD recorder 1, since it is possible to make the external circumferential portion upon which the finalized data has been recorded blank by rewriting it.

It should be understood that the device of this embodiment is not limited to being a device which records DVDs; the present invention may also be applied to a device which records some other type of optical disk.

The control unit 2 is endowed with a clock function which maintains the present time, and is also endowed with the function of generating various menus for actuation, as will be described hereinafter. This function of generating menus is a function in which so called OSD images are generated.

A television broadcast signal which has been received by an antenna not shown in the figures is inputted to the input unit 3. This input unit 3 comprises a tuner which extracts the television broadcast signal upon a selected channel from the television broadcast signal which is inputted thereto. And the input unit 3 inputs the video signal of the television broadcast which has thus been extracted by this tuner to the recording signal processing unit 4. Moreover, the input unit 3 inputs the audio signal of the title which is being broadcast upon the selected channel to the recording signal processing unit 4.

If the signal of the title which is being inputted to the recording signal processing unit 4 from the input unit 3 is an analog signal, then the recording signal processing unit 4 converts that signal to a digital signal. And the recording signal processing unit 4 acquires the video data and audio data from the signal of the title which is inputted, and encodes the thus acquired image data and audio data. Then the recording signal processing unit 4 outputs this encoded data to the recording/reading unit 5, as recording data to be recorded upon the DVD.

The recording/reading unit 5 irradiates laser light upon the DVD, and comprises a pickup head (not shown in the figures) which detects reflected light, and a servo control unit (also not shown in the figures) which performs focus servo control and tracking servo control and so on for controlling the position at which the laser light is irradiated upon the DVD 10. With this structure, the recording/reading unit 5 performs recording control by modulating the laser light irradiated upon the DVD, based upon the recording data which is to be recorded upon this DVD. Furthermore, during playback, the recording/reading unit 5 outputs to the read signal processing unit 6 an RF signal which has been read in from the recorded data of a title recorded upon the DVD.

After having extracted the video data and the audio data from this RF signal outputted from the recording/reading unit 5, the read signal processing unit 6 decodes them, and inputs the video data and audio data which have thus been decoded to the output unit 7.

A display device 11 which displays a video image, and a speaker 12 which emits audio, are connected to the output unit 7. The output unit 7 synchronizes and outputs a replay video signal which it creates based upon the video data inputted from the read signal processing unit 6, and a replay audio signal which it creates based upon the audio data. The replay video signal is outputted to the display device 11. The output unit 7 is also endowed with a function of outputting a title menu image which has been created by the control unit 2. Moreover, the replay video signal is outputted by the output unit 7 to the display device 11, while the replay audio signal is outputted to the speaker 12.

The storage unit 8 comprises a hard disk 8a (a HD 8a) which is a storage medium, and a hard disk drive 8b (a HDD 8b) which performs recording of data upon this hard disk 8 and reading out of data therefrom. Information about the disk menu copied to the DVD 10 is recorded in this storage unit 8.

It should be understood that, with the DVD recorder 1 of this embodiment, it is not actually necessary to provide the hard disk 8a and the hard disk drive 8b. For example, as a structure for the storage unit 8, it would also be acceptable to provide a structure comprising a fixed memory which, when recording upon the DVD 10, stores the menu for actuation copied to the DVD 10, the manufacturer ID, and the menu layout ID.

The actuation unit 9 comprises a remote control device not shown in the figures which has a plurality of actuation keys, and a remote control reception unit which receives control codes for the device main body from this remote control device. With this structure, the actuation unit 9 inputs to the control unit 2 codes corresponding to actuation keys which are actuated by the user, and control codes which are received by the remote control reception unit.

The display device 11 displays an image based upon the replay video signal which is inputted thereto. And the speaker 12 emits sound based upon the replay audio signal which is inputted thereto.

In the following, the operation of this DVD recorder 1 according to an embodiment of the present invention will be explained. The DVD recorder of this embodiment records a title upon a DVD which is loaded into its main body. Since this recording of a title upon the DVD is, per se, the same in outline as in the case of a conventional DVD recorder, it will here be explained in a simple manner. When an input related to starting recording of a title upon the DVD has been performed, or when a video recording start time point at which video recording has been appointed to start arrives, this DVD recorder starts recording the title upon the DVD. The title to be recorded upon the DVD is inputted to the input unit 3. The recording signal processing unit 4 encodes the image data and the audio data to be recorded upon the DVD. The recording/reading unit 5 controls the pulse modulation and the laser power and so on of the laser light irradiated by the pickup head upon the DVD, based upon this data which has been encoded by the recording signal processing unit 4. Furthermore it also records, upon a read-in region of the DVD, information relating to the title name of the title which is to be recorded this time, the recording date and time, and the recording start position and the recording end position.

According to the specification of the DVD recorder 1 of this embodiment, as a presupposition to newly appending and recording a title, it is supposed that the DVD 10 in use is one which has been manufactured by the same company as the one which manufactured this DVD recorder 1 into which this DVD 10 is loaded, and moreover one upon which a specified menu is recorded. When a DVD 10 which does not fulfill this specification is loaded into this DVD recorder 1, it is not possible to rewrite it to record a new title, or to perform additional recording thereon. Thus, in order to fulfill this specification, it is necessary to rewrite the disk menu recorded upon the DVD 10.

Here, general information about setting screens for setting various types of operation of this DVD recorder is recorded upon the DVD 10 upon which the title is recorded; and, specifically, this information is recorded upon the disk in the file VRMI_GI (Video Recording Manager Information—General Information). And the manufacturer ID and the menu layout ID and the like are recorded in this file VRMI_GI. According to the specification of the DVD recorder 1 as previously described, when adding a title to the DVD 10, it is not possible to perform recording if these IDs are not those of the DVD recorder 1. Since there is a danger that the user will suffer some disadvantage if the menu screen is changed freely without restriction, accordingly it is necessary to ask the user for his consent to rewriting of the manufacturer ID and disk menu. However, if a consent screen is displayed every time video recording is performed, this will give the user a considerable amount of trouble.

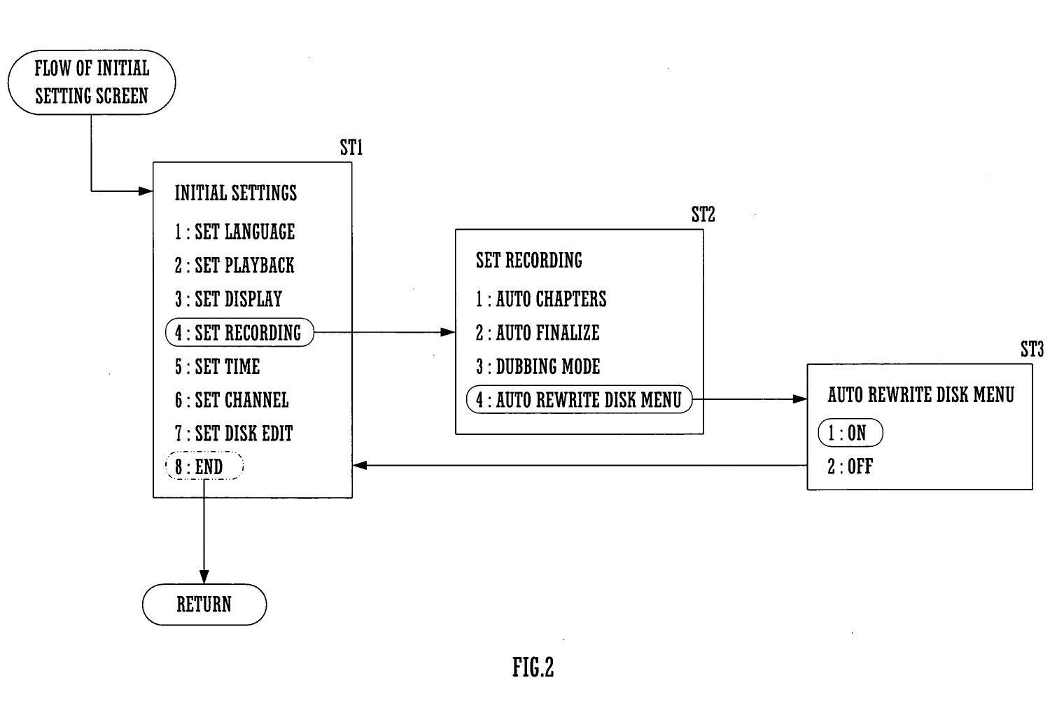

Using the flow diagram of FIG. 2, the processing performed by the control unit 2 for eliminating the trouble to the user caused (in the prior art) by his consent being required for rewriting of the manufacturer ID will now be explained. FIG. 2 is a flow diagram showing the shifting from screen to screen upon a setup screen which is used by the user for setting the operation of the DVD recorder 1 in advance.

In the stage ST1, eight setting items are displayed, as shown in FIG. 2. During the display of this screen, a field selection is received via a cursor key of the remote control of the actuation unit 9 (not shown in the figures). When this cursor key is depressed, the highlighted portion shifts upon the screen, so that the fact that this field is being selected is displayed.

With the item “1. Set Language” of the stage ST1 of FIG. 2, it is possible for the user to make a selection for setting the language in which the menu is to be displayed. With the item “2. Set Playback”, it is possible for the user to select settings for replaying video recording data which has been recorded. With the item “3. Set Display”, it is possible for the user to select a setting for the screen of the television receiver, such as a setting for a screen ratio of 16:9 or the like. With the item “4. Set Recording”, it is possible for the user to select settings for operation during video recording. With the item “5. Set Time ”, it is possible for the user to select a setting for the present time. With the item “6. Set Channel”, it is possible for the user to select a channel to be set, so as to be able to perform video recording of a television broadcast. And, with the item “7. Set Disk Edit”, it is possible for the user to select setting operations for disk editing.

When, at the stage ST1 of FIG. 2, a confirmation key (not shown in the figures) is pressed in the state with the selection of any of the setting items being highlighted, then the system shifts to a deeper setting screen for this item. If this confirmation key (not shown in the figures) is pressed while the item “4. Set Recording” is being selected, then the system shifts to the setting screen of the stage ST2. Moreover, upon the item “8. End” being selected, the initial setting operation in which the user can make settings is terminated, and the flow shown in this figure stops.

If the item “4. Set Recording” is selected at the stage ST1, then, at the stage ST2 of FIG. 2, four setting items are displayed. During display of this screen, selection of a field with the cursor key (not shown in the figures) of the remote control of the actuation unit 9 is received.

With the item “1. Auto Chapters”, the user is able to select a setting, when performing recording upon a DVD-R/RW in the video mode, for dividing the recording automatically into chapters of a designated length.

With the item “2. Auto Finalize”, the user is able to select whether or not finalize processing is to be automatically performed after video recording has ended. And, with the item “3. Dubbing Mode”, the user is able to select from which device, and to which device, dubbing is to be performed.

When any of the above setting items has been selected, and when the confirmation key (not shown in the figures) is pressed, then the system shifts to a deeper setting screen for this respective item. For example, in the case of the fourth item “4. Auto Rewrite Disk Menu”, the user is able to select an operation at the stage ST3 which will now be explained.

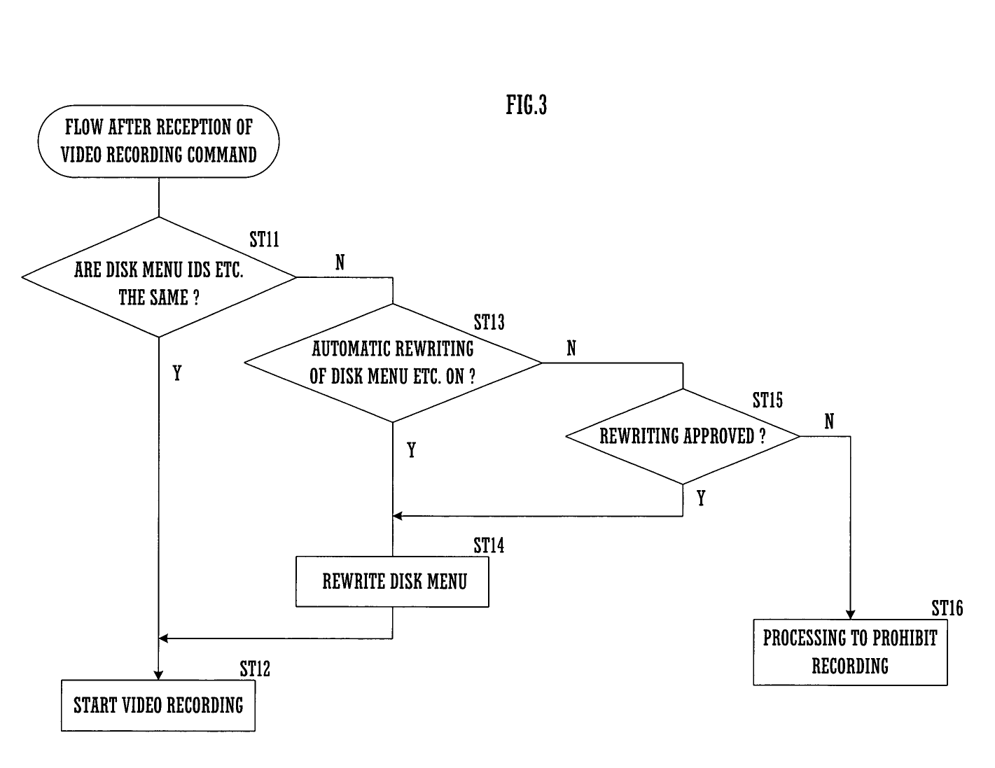

In this stage ST3 of FIG. 2, a selection screen is displayed for the user to make a YES/NO setting in advance for the operation of “4. Auto Rewrite Disk Menu”, in order to avoid the troublesome procedure of asking the user for his consent to rewriting the manufacturer ID etc., each time video recording is performed, or each time the DVD 10 which is loaded is changed. It is possible for the user to select either of the settings “1. ON” or “2. OFF” for the “4. Auto Rewrite Disk Menu” mode, and, when he presses the confirmation key, this mode is set to either “1. ON” or “2. OFF”, and then the system returns to the stage ST1. The operation for both of these cases in which this “4. Auto Rewrite Disk Menu” mode is set to “1. ON” and to “2. OFF” will be explained with reference to FIG. 3, as will be described hereinafter.

It should be understood that it is not necessary for eight setting items to be shown at the stage ST1 of FIG. 2. Moreover, it is also not necessary for four setting items to be shown at the stage ST2 of FIG. 2.

Next, using the flow chart of FIG. 3, the processing when the control unit 2 receives from the actuation unit 9 a command for directly performing video recording, or an appointment command for subsequent video recording, will be explained.

In a step ST11, the control unit 2 commands the recording/reading unit 5 to read in the manufacturer ID and the menu layout ID from the DVD which is currently loaded in the DVD recorder 1, and then it decides, from these values which have been read in, whether or not both of these IDs are the same as those stored in the DVD recorder 1. If these IDs are the same (Y in the step ST11), then the flow of control proceeds to a step ST12. In this case, the previously described condition for the DVD recorder 1 to append and record this title, i.e. “the DVD recorder 1 in which the DVD is loaded is produced by the same manufacturer as the DVD, and moreover the designated menu is recorded”, is satisfied. Conversely, if these IDs are not the same as those stored in the DVD recorder 1 (N in the step ST11), then the flow of control proceeds to a step ST13. In this case, since this condition is not satisfied, the control unit 2 cannot record the title by simply proceeding.

In the step ST12 of FIG. 3, the recording/reading unit 5 is commanded to newly record a title. The branch to this step ST12 is from Y decisions in the steps ST11, ST13, and ST15.

A branch off to the step ST13 takes place if either the manufacturer ID or the menu layout ID read from the DVD currently loaded in the DVD recorder 1 is different from the one stored in the DVD recorder 1. In this step ST13, a decision is made as to whether or not the value of the step ST3 of FIG. 2 for automatic rewriting of the disk menu is set to “ON”. If this value set in the step ST3 is “ON” (Y in the step ST13), then the flow of control proceeds to a step ST14 which will be described hereinafter, and the disk menu and so on is rewritten. But if this value set in the step ST3 is “OFF” (N in the step ST13), then the flow of control proceeds to a step ST15.

In the step ST14, the control unit 2 commands the recording/reading unit 5, directly before video recording, to rewrite, upon this DVD which is loaded, each of the disk menu, the manufacturer ID, and the menu layout ID to those upon the DVD recorder 1 which is currently in use. The reason for only performing this rewriting of these menus and so on directly before video recording, is because sometimes the user may subsequently abandon video recording after an appointment for video recording has been made, since a certain time period elapses from making the appointment until the video recording is actually performed thereafter.

It should be understood that, in the case of a rewritable type DVD, in this step ST14, together with this menu rewriting, the control unit 2 returns the finalized region to the blank state.

Branching to the step ST15 of FIG. 3 takes place in the case in which a DVD which does not satisfy the ID condition previously described has been loaded (N in the step ST11), and moreover the automatic rewriting of the disk menu set in the initial setting shown in FIG. 2 is OFF (N in the step ST13). In this step ST15, along with outputting a display for confirmation of this rewriting of the disk menu to the display device 11, a decision is made as to whether or not consent thereto has been given via the actuation unit. If a selection has been made to the effect that the user consents to rewriting of the disk menu (Y in the step ST15), then the flow of control is transferred to the step ST14. In this step ST14, as before, the control unit 2 issues a command for rewriting, upon this DVD which is loaded, each of the disk menu, the manufacturer ID, and the menu layout ID to those upon the DVD recorder 1 which is currently in use. On the other hand, if a selection is made to the effect that the user does not consent to this rewriting of the disk menu (N in the step ST15), then the flow of control is transferred to the step ST16.

The step ST16 of FIG. 3 is a branch which is reached when the condition of the step ST15 is not satisfied. In this step ST16 the output unit 7 outputs to the display device 11, for 1 example, the warning display “This disk has been recorded with another company's DVD recorder, and cannot be recorded unless its menu is rewritten to the dedicated menu of this DVD recorder”. And, in this step ST16, the control unit 2 does not issue any command for video recording.

As described above, in the flow chart of FIG. 3, if the manufacturer ID upon the DVD is the same as that of the present disk recording device (Y in the step ST1), then incremental video recording is started without any special procedure (in the step ST12). If, in the initial setting menu, the item “4. Change disk menu automatically” is set to ON (Y in the step ST13), or if a selection has been made to the effect that rewrite confirmation is consented to (Y in the step ST15), then, after rewriting the disk menu in the step ST14, the video recording is started (in the step ST12). If any of the above is not the case (N in the step ST11, N in the step ST13 or N in the step ST15), then in the step ST16 processing is performed to prohibit video recording (i.e., no command for video recording is issued). Since in this manner it is possible to make a selection, with the initial setting shown in FIG. 2, to the effect that the disk menu may be automatically rewritten, accordingly, provided that the user turns disk menu automatic rewriting ON with this initial setting, the confirmation screen of the step ST15 is not displayed each time that video recording upon a different type of DVD is performed, but simply the disk menu is automatically rewritten (in the step ST14) and video recording is started (in the step ST12).

What is claimed is:

1. A disk recording device comprising a recording means which records data upon an optical disk loaded to a main body of said device, comprising:
an ID information decision means which decides whether or not first ID information, which is ID information recorded upon said loaded optical disk for a first disk menu also recorded thereupon, and second ID information, which is ID information stored in said disk recording device for a second disk menu also stored therein, agree with one another;
a menu rewrite reception means which receives in advance a rewrite command to rewrite said disk menu; and
a menu rewriting means which, if said rewrite command has been received in advance by said menu rewrite reception means, and if said ID information decision means decides that said first ID information and said second ID information do not agree with one another, rewrites, using said recording means, said first disk menu and said first ID information recorded upon said optical disk to said second disk menu and said second ID information stored in said disk recording device.

2. A disk recording device as described in claim 1, wherein, if no said rewrite command has been received by said menu rewrite reception means, and if said ID information decision means decides that said first ID information and said second ID information do not agree with one another, then said menu rewriting means outputs a confirmation screen to receive confirmation for said rewriting, and, when said confirmation is received, rewrites, using said recording means, said first disk menu and said first ID information recorded upon said optical disk to said second disk menu and said second ID information stored in said disk recording device.
